(19) United States
(12) Patent Application Publication
(10) Pub. No.: US 2026/0304451 A1
(43) Pub. Date: Oct. 1, 2026

(54) CONFIGURATION FOR SIDELINK TRANSMISSIONS

(71) Applicant: Lenovo (Beijing) Limited, Beijing (CN)

(72) Inventors: Xiaodong Yu, Beijing (CN); Haipeng Lei, Beijing (CN); Zhennian Sun, Beijing (CN); Xin Guo, Beijing (CN)

(73) Assignee: Lenovo (Beijing) Limited, Beijing (CN)

(21) Appl. No.: 19/472,604

(22) PCT Filed: Apr. 4, 2023
(86) PCT No.: PCT/CN2023/086168

§ 371 Date: Oct. 3, 2025

(51) Int. Cl. H04W 72/25; H04W 74/0808

(52) U.S. Cl. CPC H04W 72/25; H04W 74/0808

(57) ABSTRACT

Embodiments of the present disclosure relate to devices, methods and a medium for sidelink communications. A terminal device obtains configuration information indicative of at least one of (i) a minimum number and a maximum number of resource block (RB) sets for a sidelink transmission, or (ii) selecting at least one same or different subchannel in each RB set for the sidelink transmission. The terminal device further selects at least one resource for the sidelink transmission by performing a resource selection procedure based on the configuration information. The terminal device further transmits, via a transceiver, sidelink control information (SCI) indicative of the at least one resource. In this way, subchannel is not limited in one RB set. The selected resource for sidelink transmission can include multiple subchannels or interlaces, and also span on multiple RB sets.

### FIELD

Embodiments of the present disclosure generally relate to the field of communication, and in particular to a terminal device, a network device, methods, and a non-transitory computer readable medium for sidelink communications.

### BACKGROUND

In telecommunications networks, such as long term evolution (LTE) networks or new radio (NR) networks, sidelink communications between user equipment (UEs) over a proximity services (ProSe) Communication 5 (PC5) wireless interface may be supported. In sidelink (SL) communications, UEs may communicate with each other directly via a PC5 wireless interface on a SL channel. Further, SL communications may achieve a plurality of advantages, such as coverage extension, service reliability enhancement, and potential low latency.

In SL-U, the minimum granularity of LBT is one RB set for unlicensed band and the unlicensed band may include one or more RB sets. The minimum granularity of listen before talk (LBT) is one RB set for the unlicensed band. The unlicensed band may include one or more RB sets. A subchannel may be limited in one RB set.

### SUMMARY

In general, embodiments of the present disclosure provide a solution for sidelink communications.

In a first aspect, there is provided a terminal device. The terminal device comprises a processor and a transceiver coupled to the processor. The processor is configured to obtain configuration information indicative of at least one of (i) a minimum number and a maximum number of resource block (RB) sets for a sidelink transmission, or (ii) selecting at least one same or different subchannel in each RB set for the sidelink transmission. The processor is further configured to select at least one resource for the sidelink transmission by performing a resource selection procedure based on the configuration information. The processor is further configured to transmit, via the transceiver, sidelink control information (SCI) indicative of the at least one resource.

In a second aspect, there is provided a network device. The network device comprises a processor and a transceiver coupled to the processor. The processor is configured to determine configuration information indicative of at least one of (i) a minimum number and a maximum number of RB sets for a sidelink transmission, or (ii) selecting at least one same or different subchannel in each RB set for the sidelink transmission. The processor is further configured to transmit, via the transceiver, the configuration information to a terminal device.

In a third aspect, there is provided a method performed by a terminal device. The method comprises obtaining configuration information indicative of at least one of (i) a minimum number and a maximum number of RB sets for a sidelink transmission, or (ii) selecting at least one same or different subchannel in each RB set for the sidelink transmission. The method further comprises selecting, at the terminal device, at least one resource for the sidelink transmission by performing a resource selection procedure based on the configuration information. The method further comprises transmitting, at the terminal device, SCI indicative of the at least one resource.

In a fourth aspect, there is provided a method performed by a network device. The method comprises determining configuration information indicative of at least one of (i) a minimum number and a maximum number of resource block (RB) sets for a sidelink transmission, or (ii) selecting at least one same or different subchannel in each RB set for the sidelink transmission. The method further comprises transmitting, at the network device, the configuration information to a terminal device.

In a fifth aspect, there is provided a non-transitory computer readable medium. The non-transitory computer readable medium having program instructions stored thereon. The program instructions, when executed by an apparatus, causing the apparatus to perform at least the methods of the third aspect or the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1 illustrates a schematic diagram of a communication environment in which some embodiments of the present disclosure can be implemented;

FIG. 2A illustrates an example signaling process for configuration for sidelink transmissions according to some embodiments of the present disclosure;

FIG. 2B illustrates another example signaling process for configuration for sidelink transmissions according to some embodiments of the present disclosure;

FIGS. 3A-3F illustrate some examples of configuration information related to numbers of RB set for sidelink transmissions according to some embodiments of the present disclosure;

FIGS. 4A-4B illustrate some examples of configuration information related to selecting same or different subchannels for sidelink transmissions according to some embodiments of the present disclosure;

FIGS. 5A-5B illustrate some examples of bitmaps related to the selected RB sets and subchannels for sidelink transmissions according to some embodiments of the present disclosure;

FIG. 6 illustrates a flowchart of an example method for configuration for sidelink transmissions according to some other embodiments of the present disclosure;

FIG. 7 illustrates another flowchart of an example method for configuration for sidelink transmissions according to some other embodiments of the present disclosure; and

FIG. 8 illustrates a simplified block diagram of a device that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term “resource,” “transmission resource,” “resource block,” “physical resource block,” “uplink resource,” “downlink resource,” or “sidelink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

As used herein, an interlace may refer to a plurality of RBs in a RB set, and the plurality of RBs may be distributed in the RB set, for example, in a comb form. In this disclosure, the interlace, common resource interlace, and common interlace may be used interchangeably, without any limitation.

As mentioned above, in SL-U, a selected resource for sidelink transmission can not only include multiple subchannels or interlaces, but also span on multiple RB set. The minimum granularity of LBT is one RB set for unlicensed band and the unlicensed band may include one or more RB sets. So the UE procedure for determining the subset of resources to be reported to higher layers in physical sidelink shared channel (PSSCH) resource selection in sidelink resource allocation mode 2 should be enhanced with considering one or more selected or available RB set.

In one solution, based on current agreement, subchannel is limited in one RB set, so legacy higher layer indication on the number of subchannel cannot restrict frequency resource size. For example, one subchannel is defined and indexed within one RB set as shown in table 1.

TABLE 1

| Agreement | |
|---|---|
| For interlace RB-based PSCCH/PSSCH transmission in SL-U: | |
| • | Regarding mapping between sub-channel |
| | and interlace, 1 sub-channel is |
| | defined and indexed within 1 RB set, |
| | and is periodically indexed across |
| | different RB sets within the resource pool |

In current technical specification (TS) 38.214, 8.1.4, it discusses the UE procedure for determining the subset of resources to be reported to higher layers in PSSCH resource selection in sidelink resource allocation mode 2. When higher layer triggers a resource selection, a number of sub-channels was provided by higher layer as shown in table 2, but RB set related information is not informed to physical layer. Thus, for SL-U, RB set related information should be provided from higher layer to physical layer. In resource allocation mode 2, the higher layer can request the UE to determine a subset of resources from which the higher layer will select resources for PSSCH/PSCCH transmission. To trigger this procedure, in slot n, the higher layer provides the following parameters for this PSSCH/PSCCH transmission as shown in table 2.

TABLE 2
To trigger this procedure, in slot n, the higher
layer provides the following parameters
for this PSSCH/PSCCH transmission:
- the resource pool from which the resources are to be reported;
- L1 priority, prio_{TX};
- the remaining packet delay budget;
- the number of sub-channels to be used for the
PSSCH/PSCCH transmission in a slot, L_{subCH};
- optionally, the resource reservation interval, Pᵣₛᵥₚ_{_{—}}_{TX}, in units of msec.

In current TS 38.321 5.22.1.1, SL Grant reception and SCI transmission are shown in table 3.

```
TABLE 3
If the MAC entity has been configured with Sidelink resource allocation mode 2 to
transmit using pool(s) of resources in a carrier as indicated in TS 38.331 [5] or TS 36.331
[21] based on full sensing, or partial sensing, or random selection or any combination(s),
the MAC entity shall for each Sidelink process:
  NOTE 1: If the MAC entity is configured with Sidelink resource allocation mode 2 to
          transmit using a pool of resources in a carrier as indicated in TS 38.331 [5] or
          TS 36.331 [21], the MAC entity can create a selected sidelink grant on the pool
          of resources based on random selection, or partial sensing, or full sensing only
          after releasing configured sidelink grant(s), if any.
  NOTE 2: The MAC entity expects that PSFCH is always configured by RRC for at least
          one pool of resources in sl-TxPoolSelectedNormal and for the resource pool in
          sl-TxPoolExceptional in case that at least a logical channel configured with
          sl-HARQ-FeedbackEnabled is set to enabled.
  1> if the MAC entity has selected to create a selected sidelink grant corresponding to
    transmissions of multiple MAC PDUs, and SL data is available in a logical channel:
  2>if the MAC entity has not selected a pool of resources allowed for the logical
    channel:
    3>if SL data is available in the logical channel for sidelink discovery:
      4>if sl-BWP-DiscPoolConfig or sl-BWP-DiscPoolConfigCommon is
        configured according to TS 38.331 [5]:
        5>select the sl-DiscTxPoolSelected configured in sl-BWP-DiscPoolConfig
          or sl-BWP-DiscPoolConfigCommon for the transmission of sidelink
          discovery message.
      4> else:
        5>select any pool of resources among the configured pools of resources.
    3>else if sl-HARQ-FeedbackEnabled is set to enabled for the logical channel:
      4>select any pool of resources configured with PSFCH resources among the
        pools of resources except the pool(s) in sl-BWP-DiscPoolConfig or
        sl-BWP-DiscPoolConfigCommon, if configured.
    3>else:
        4> select any pool of resources among the pools of resources except the pool(s)
          in sl-BWP-DiscPoolConfig or sl-BWP-DiscPoolConfigCommon, if
          configured.
  2>perform the TX resource (re-)selection check on the selected pool of resources as
    specified in clause 5.22.1.2;
NOTE 3: The MAC entity continuously performs the TX resource (re-)selection check
        until the corresponding pool of resources is released by RRC or the MAC entity
        decides to cancel creating a selected sidelink grant corresponding to
        transmissions of multiple MAC PDUs.
  2>if the TX resource (re-)selection is triggered as the result of the TX resource
    (re-)selection check:
    3>if one or multiple SL DRX is configured in the destination UE(s) receiving
    SL-SCH data:
      4> indicate to the physical layer SL DRX Active time in the destination UE(s)
        receiving SL-SCH data, as specified in clause 5.28.2.
    3>select one of the allowed values configured by RRC in
      sl-ResourceReservePeriodList and set the resource reservation interval,
      Pᵣₛᵥₚ_TX, with the selected value;
NOTE 3A: The MAC entity selects a value for the resource reservation interval
        which is larger than the remaining PDB of SL data available in the logical
        channel.
    3>randomly select, with equal probability, an integer value in the interval [5, 15]
      for the resource reservation interval higher than or equal to 100ms or in the
      interval
      $interval [ 5 \times ⌈ \frac{100}{max ( 20 , {P}_{rsvp \_ TX} )} ⌉ , 15 \times ⌈ \frac{100}{max ( 20 , {P}_{rsvp \_ TX} )} ⌉ ] for the resource$
      reservation interval lower than 100ms and set
      SL RESOURCE RESELECTION COUNTER to the selected value;
    3>select the number of HARQ retransmissions from the allowed numbers, if
      configured by RRC, in sl-MaxTxTransNumPSSCH included in
      sl-PSSCH-TxConfigList and, if configured by RRC, overlapped in
      sl-MaxTxTransNumPSSCH indicated in sl-CBR-PriorityTxConfigList for the
      highest priority of the logical channel(s) allowed on the carrier and the CBR
      measured by lower layers according to clause 5.1.27 of TS 38.215 [24] if CBR
      measurement results are available or the corresponding
      sl-defaultTxConfigIndex configured by RRC if CBR measurement results are
      not available;
    3> select an amount of frequency resources within the range, if configured by RRC,
      between sl-MinSubChannelNumPSSCH and sl-MaxSubchannelNumPSSCH included in
sl-PSSCH-TxConfigList and, if configured by RRC, overlapped between
MinSubChannelNumPSSCH and MaxSubchannelNumPSSCH indicated in
sl-CBR-PriorityTxConfigList for the highest priority of the logical channel(s) allowed on
the carrier and the CBR measured by lower layers according to clause 5.1.27 of TS
38.215 [24] if CBR measurement results are available or the corresponding
sl-defaultTxConfigIndex configured by RRC if CBR measurement results are not
available;
```

In agreement from RAN1 #112, one subchannel is defined and indexed within one RB set, as shown in table 4.

TABLE 4

| Agreement | |
|---|---|
| For interlace RB-based PSCCH/PSSCH transmission in SL-U: | |
| • | Regarding mapping between sub-channel and |
| | interlace, 1 sub-channel is defined |
| | and indexed within 1 RB set, and is |
| | periodically indexed across different RB sets |
| | within the resource pool |

In view of the above, on current agreement, a subchannel is limited in one RB set, so legacy higher layer indication on the number of subchannel cannot restrict frequency resource size. Therefore, in order to enhance with considering one or more selected/available RB set, a new higher layer indication is needed. The present disclosure proposed higher layer parameters for resource indication selection in a SL-U. The higher layer parameters relate to RB sets and subchannels. The present disclosure further proposed a higher layer selecting parameter procedure. The present disclosure further provides higher layer provided information to physical layer for resource selection, and indication filed in SCI for indicating same or different the subchannels or subchannel index in each RB set.

In this way, subchannel is not limited in one RB set. The selected resource for SL transmission can include multiple subchannels or interlaces, and also span on multiple RB set. A new higher layer indication is also provided. Thus, higher layer indication on the number of subchannel does not restrict frequency resource size, and candidate resource reporting for SL-U can be extended to multiple RB set.

Principle and embodiments of the present disclosure will be described in detail below with reference to the accompanying drawings.

### Example Environment

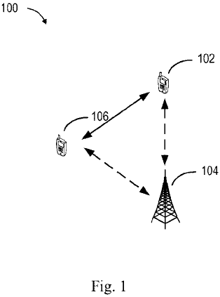

FIG. 1 illustrates an example communication environment 100 in which example embodiments of the present disclosure may be implemented. The communication environment 100, which may be a part of a communication network, includes a terminal device and a network device.

As illustrated in FIG. 1, the communication environment 100 may comprise a terminal device 102 and a terminal device 106. The terminal device 102 may also be referred as a user equipment 102 or a UE 102. The terminal device 106 may also be referred as a user equipment 106 or a UE 106. The terminal device 102 may communicate with the terminal device 106 via sidelink channels. For example, the terminal device 102 may transmit an acknowledge (ACK) or non-ACK message for a data transmission to the terminal device 106.

The communication environment 100 may comprise a network device 104. The network device 104 may also be referred as a gNB 104. The network device 104 may communicate with the terminal device 102. The network device 104 may determine configuration information indicative of a minimum number and a maximum number of RB sets for a sidelink transmission. The network work device 104 may determine configuration information indicative of selecting at least one same or different subchannel in each RB set for the sidelink transmission. The network work device 104 may transmit the configuration information to the terminal device 102.

The terminal device 102 may obtain the configuration information. For example, the configuration information is preconfigured. For another example, the terminal device 102 may receive the configuration information.

The terminal device 102 may select, based on the configuration information, at least one resource for the sidelink transmission by performing a resource selection procedure. The terminal device 102 may transmit SCI indicative of the at least one resource.

It is to be understood that the number of terminal devices is given only for the purpose of illustration without suggesting any limitations. The communication environment 100 may include any suitable number of network devices and/or terminal devices adapted for implementing embodiments of the present disclosure.

Communications in the communication environment 100 may be implemented according to any proper communication protocol(s), comprising, but not limited to, the third generation (3G), the fourth generation (4G), the fifth generation (5G), 5G-Advanced or beyond (6G), wireless local network communication protocols such as institute for electrical and electronics engineers (IEEE) 802.11 and the like, and/or any other protocols currently known or to be developed in the future. Moreover, the communication may utilize any proper wireless communication technology, comprising but not limited to: orthogonal frequency division multiplexing (OFDM), time division multiplexing (TDM), frequency division multiplexing (FDM), code division multiplexing (CDM), spatial division multiplexing (SDM) by means of beam-forming or multiple-input multiple-output (MIMO) transmission, carrier aggregation (CA), dual connectivity (DC), new radio unlicensed (NR-U) communication, Bluetooth, ZigBee, etc. The communication may be of any type, comprising but not limited to: machine type communication (MTC), enhanced mobile broadband (eMBB), massive machine type communication (mMTC), ultra-reliable low latency communication (URLLC), etc.

At least for solving the above issues, this disclosure provided a method for sidelink communications. It is to be understood that although the embodiments are mainly discussed with reference to the PSSCH, the embodiments may be also applied to any other communication channels or links.

### Example Communication Process

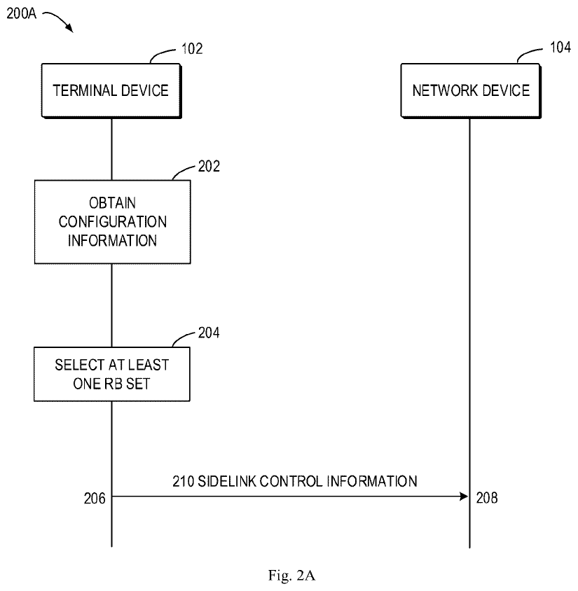

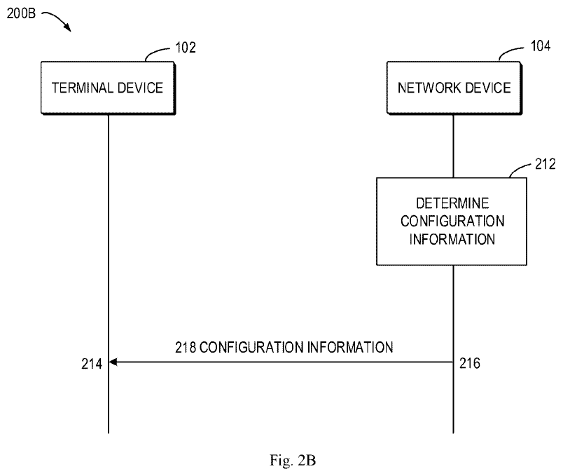

FIG. 2A illustrates an example signaling process 200A for configuration for sidelink transmissions according to some embodiments of the present disclosure. For the purpose of discussion, the signaling process 200A will be described with reference to FIG. 1. It would be appreciated that although the signaling process 200A has been described in the communication environment 100 of FIG. 1, this signaling process 200A may be likewise applied to other communication scenarios.

As shown in FIG. 2A, the terminal device 102 obtains (202) configuration information. In some example embodiments, the configuration information may indicate a minimum number and a maximum number of RB sets for a sidelink transmission. In some other embodiments, the configuration information may indicate selecting at least one same or different subchannel in each RB set for the sidelink transmission. In some further embodiments, the configuration information may indicate both of the two items. As an example, the terminal device 102 may receive the configuration information from the network device 104. As another example, the terminal device 102 may be configured with the configuration information.

For example, the terminal device 102 may receive a configuration information which is configured or preconfigured per resource pool via RRC signaling. The configuration information comprise may two parameters, which are sl-MinRBsetNumPSSCH and sl-MaxRBsetNumPSSCH. The two parameters may indicate the minimum and maximum number of RB sets which may be used for transmissions on PSSCH.

For another example, the terminal device 102 may receive a configuration information which is configured or preconfigured per resource pool via RRC signaling. The configuration information may comprise a parameter of SubchannelinRBset, which indicates the terminal device 102 should select same subchannels or subchannel indexes, or the terminal device 102 should select different subchannels or subchannel indexes in each RB set.

The terminal device 102 selects (204) at least one resource for the sidelink transmission by performing a resource selection procedure based on the configuration information. As an example, in case that configuration information indicates that the minimum number and the maximum number of RB sets are one and three, and in case that the configuration information indicates to select same subchannel in each RB set. The terminal device 102 may determine the number of available RB sets is two, which is within a range of the minimum number and the maximum number of RB sets. The terminal device 102 may select two subchannels in each RB sets, and periodically across different RB sets within the resource pool.

For instance, higher layer of the terminal device 102 may select or determine the number of RB sets for PSSCH transmission for resource selection procedure based on sl-MinRBsetNumPSSCH and sl-MaxRBsetNumPSSCH. Higher layer of the terminal device 102 may provide the selected or determined number of RB sets to physical layer for the triggered resource selection in slot n. For example, the higher layer may provide parameters for indicating the number of RB set to be used for the PSSCH/PSCCH transmission in a slot.

In some example embodiment, the terminal device 102 may select or determine the available of RB sets for PSSCH transmission for resource selection procedure. Meanwhile, the available of RB set may be selected or determined based on consistent LBT failure detection result. The higher layer may provide the available RB sets or RB set indexes to physical layer for the triggered resource selection in slot n. For example, the higher layer may provide parameters for this PSSCH/PSCCH transmission, which indicate the available RB sets or RB set indexes to be used for the PSSCH/PSCCH transmission in a slot based on consistent LBT failure detection result.

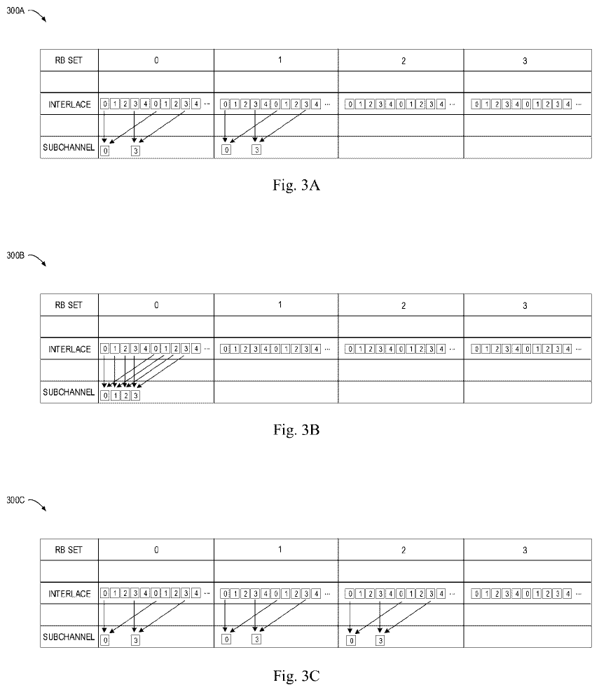

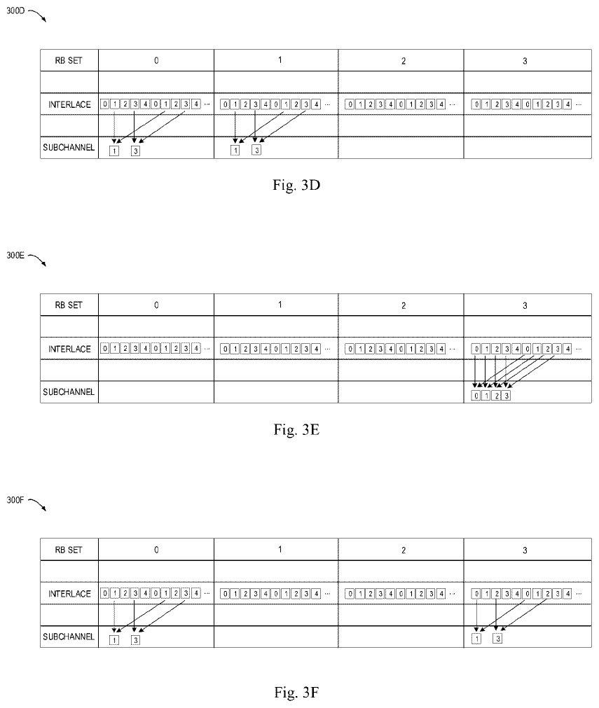

For better understanding, reference is made to FIGS. 3A-3F, which illustrate some examples of configuration information related to numbers of RB set for sidelink transmissions according to some embodiments of the present disclosure.

In some example embodiments, if higher layer provides the selected or determined number of RB sets to physical layer for the triggered resource selection in slot n, the terminal device 102 should select candidate resource within continuous RB sets in frequency domain. For example, the number of RB set is two, the terminal device should select resources from one of: {RB set 0}, {RB set 1}, {RB set 2}, {RB set 3}, {RB set 0, RB set 1}, {RB set 1, RB set 2} or {RB set 2, RB set 3}. These may be understood with reference to FIGS. 3A and 3B. As shown in FIG. 3A, subchannels 0 and 3 are selected in RB sets 0 and 1. As shown in FIG. 3B, subchannels 0-3 are selected in RB sets 0.

In some example embodiments, if higher layer of the terminal device provides the available RB sets or RB set indexes to physical layer for the triggered resource selection in slot n. The terminal device should select candidate resource within continuous RB sets in frequency domain.

For example, the available RB sets are {RB set 0, RB set 1, RB set 2}, the terminal device should select resources from one of the following: {RB set 0, RB set 1, RB set 2}, {RB set 0, RB set 1}, {RB set 1, RB set 2}, {RB set 0}, {RB set 1}, {RB set 2}. As shown in FIG. 3C, continuous RB sets 0-2 are selected.

For another example, the available RB sets are {RB set 0, RB set 1, RB set 3}, the terminal device 102 should select resources from one of the following: {RB set 0, RB set 1}, {RB set 1}, {RB set 2}, or {RB set 3}. As shown in FIG. 3D, continuous RB sets 0-1 are selected.

For yet another example, the available RB sets are {RB set 0, RB set 1, RB set 3}, the terminal device 102 should select resources from one of the following: {RB set 0, RB set 1}, {RB set 1}, {RB set 2}, or {RB set 3}. As shown in FIG. 3E, RB set 3 is selected, this is because RB 2 is not available, and RB 1 is not adjacent to RB 3.

In some example embodiments, if higher layer provides the available RB sets or RB set indexes to physical layer for the triggered resource selection in slot n. The terminal device 102 is indicated or configured to select non-continuous RB sets (i.e., additional preconfiguration or configuration information per resource pool or higher layer indication), and the terminal device 102 can select candidate resource within non-continuous RB sets in frequency domain. For example, in case that the available RB sets are {RB set 0, RB set 1, RB set 3}, the terminal device 102 should select resources from one of the following: {RB set 0, RB set 1, RB set 3}, {RB set 0, RB set 1}, {RB set 1, RB set 3}, {RB set 0, RB set 3}, {RB set 0}, {RB set 1}, or {RB set 3}. As shown in FIG. 3F, non-continuous RB sets 0 and 3 are selected. In some example embodiment, although the configuration information indicates that selecting non-continuous RB sets, continuous RB sets can be selected.

Referring back to FIG. 2A. The configuration information may indicate that a terminal device can select same or different subchannels in each RB set. To achieve this point, a parameter SubchannelinRBset is proposed. SubchannelinRBset may indicate a terminal device should select same subchannels or subchannel indexes in each RB set.

In some example embodiment, the higher layer of terminal device may select or determine to select same subchannels, or subchannel indexes in each RB set for PSSCH transmission for resource selection procedure. To trigger this procedure, in slot n, the higher layer may provide parameters indicating that select same subchannels or subchannel indexes in each RB set.

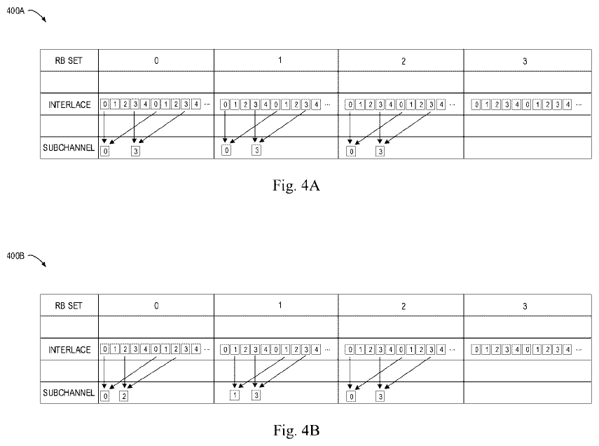

For better understanding, reference is made to FIGS. 4A-4B, which illustrate some examples of configuration information related to selecting same or different subchannels for sidelink transmissions according to some embodiments of the present disclosure.

For example, the terminal device may receive configuration information which is configured per resource pool via RRC signalling. The configuration information may indicate that the terminal device 102 should select same subchannels in each RB set when the resource selection is performed and the selected resources spanning on multiple RB sets.

If higher layer indicates physical layer to select same subchannels in each RB set, during resource selection procedure, the terminal device 102 should report the candidate resource with same the subchannels or subchannel indexes in each RB set. As shown in FIG. 4A, same subchannels 0 and 3 are selected in each of the RB sets 0-2.

In some example embodiments, higher layer of the terminal device 102 may select or determine to select same or different subchannels or subchannel indexes in each RB set for PSSCH transmission for resource selection procedure. Furthermore, to select same or different subchannels or subchannel indexes in each RB set, a number can be selected or determined within a range of the maximum and the minimum number.

For example, higher layer may provide to select same or different subchannels or subchannel indexes in each RB set to physical layer for the triggered resource selection in slot n. If higher layer indicates physical layer to select same subchannels in each RB set, during resource selection procedure, the terminal device 102 should report the candidate resource with same the subchannels or subchannel indexes in each RB set. As shown in FIG. 4A, same subchannels 0 and 3 are selected in each of the RB sets 0-2.

If higher layer indicates physical layer can select different subchannels in each RB set, during resource selection procedure, the terminal device can report the candidate resource with same or different the subchannels or subchannel indexes in each RB set. As shown in FIG. 4B, subchannels 0 and 2 are selected in RB sets 0, and subchannels 1 and 3 are selected in RB sets 1, and subchannels 0 and 3 are selected in RB sets 2.

In some example embodiments, the configuration information may indicate channel busy ratio (CBR) threshold, or channel occupancy ratio (CR) threshold. In this case, the configuration information may comprise a parameter of CBR threshold SubchannelinRBset or a parameter of CR threshold SubchannelinRBset. The parameter of CBR threshold SubchannelinRBset or the parameter of CR threshold SubchannelinRBset indicates that UE can select same or different subchannels or subchannel indexes in each RB set based on a configured or preconfigured CBR threshold or CR threshold.

After receiving the parameter of CBR threshold SubchannelinRBset or the parameter of CR threshold SubchannelinRBset, if the measured CBR of the resource pool is equal to or greater than the preconfigured CBR threshold (i.e., traffic load is high in this resource pool), higher layer of the terminal device may select or determine different subchannels or subchannel indexes in each RB set. Otherwise, if the measured CBR of the resource pool is less than a preconfigured CBR threshold (i.e., traffic load is low in this resource pool), higher layer may select or determine same subchannels or subchannel indexes in each RB set.

If the measured CBR of the resource pool is greater than the preconfigured or configured CBR threshold (i.e., traffic load is high in this resource pool), higher layer may select or determine different subchannels or subchannel indexes in each RB set. Otherwise, if the measured CBR of the resource pool is equal to or less than the preconfigured or configured CBR threshold (i.e., traffic load is low in this resource pool), higher layer may select or determine same subchannel or subchannel indexes in each RB set.

In some example embodiments, higher layer of the terminal device 102 may select different subchannels or subchannel index in each RB set. To trigger this procedure, in slot n, the higher layer may provide parameters for this PSSCH/PSCCH transmission, which indicate UE can select different subchannels or subchannelindex in each RB set.

For example, if higher layer indicates physical layer can select different subchannels in each RB set, during resource selection procedure, UE can report the candidate resource with same or different the subchannels or subchannel indexes in each RB set.

In some example embodiments, higher layer of the terminal device 102 may provide the number of subchannels to be used for PSSCH/PSCCH transmission per RB set and the selected or determined the number of RB sets or RB sets indexes to physical layer for the triggered resource selection in a slot. For example, to trigger this procedure, in slot n, the higher layer may provide parameters for this PSSCH/PSCCH transmission. The parameters indicate the number of RB sets or RB set indexes to be used for the PSSCH/PSCCH transmission in a slot, and the number of sub-channels to be used for the PSSCH/PSCCH transmission per RB set in a slot. The number of subchannels is provided for each RB set and number of subchannels for each RB set is same.

In some example embodiments, higher layer of the terminal device may provide a set of number of subchannels to be used for PSSCH/PSCCH transmission corresponding to multiple RB sets and the selected or determined the number of RB sets or RB sets indexes to physical layer for the triggered resource selection in a slot. To trigger this procedure, in slot n, the higher layer may provide parameters for this PSSCH/PSCCH transmission which indicate the following (i) to (iv), where (i): the number of RB sets or RB set indexes to be used for the PSSCH/PSCCH transmission in a slot, (ii): the number of sub-channels to be used for the PSSCH/PSCCH transmission for RB set 1 in a slot, (iii): the number of sub-channels to be used for the PSSCH/PSCCH transmission for RB set 2 in a slot, (iv): the number of sub-channels to be used for the PSSCH/PSCCH transmission for RB set 3 in a slot. Likewise, the number of sub-channels to be used for the PSSCH/PSCCH transmission for RB set n in a slot, where n is an integer larger than three. Here, a set of number of sub-channels are provided from higher layer and the number of subchannels is provided separately for each RB set.

Referring back to FIG. 2A. The terminal device 102 transmits (206), via a transceiver, SCI 210 indicative of the at least one resource. The network device 104 receives (208) the SCI 210 from the terminal device 102. As for the above example, the terminal device 102 may transmit SCI indicative of the two selected available RB sets.

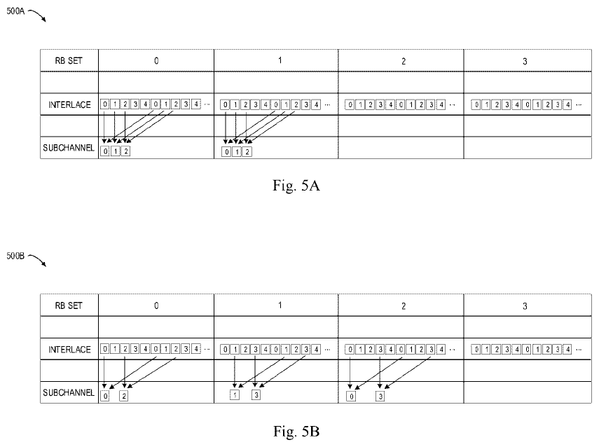

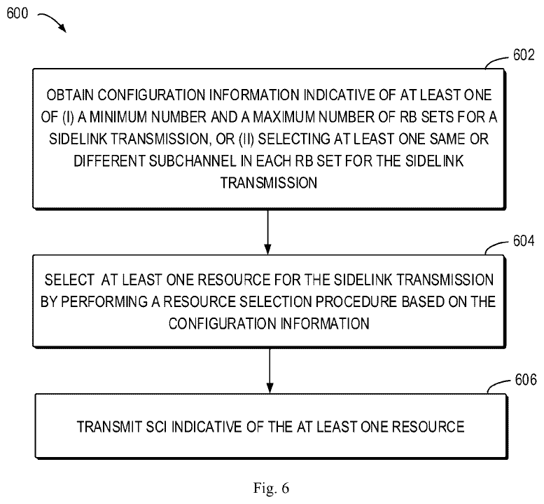

In some example embodiments, a SCI field determination based on the configuration information is indicated by a bitmap. For better understanding, this scenario is described with reference to FIGS. 5A-5B, which illustrate some examples of bitmaps related to the selected RB sets and subchannels for sidelink transmissions according to some embodiments of the present disclosure.

In some example embodiments, the configuration information indicates that selecting same subchannels in each RB set. The RB set index indicates the used RB sets for PSSCH/PSCCH transmission, and the subchannel index indicates the used subchannel index for PSSCH/PSCCH transmission.

For example, as shown in FIG. 5A, indication field includes 9 bits in bitmap manner (the bit length of the indication field=number of RB sets+number of subchannels). For example, bits ‘1100’ represent that RB sets 0 and 1 from RB sets {0,1,2,3} are used. Bits ‘11100’ represent that subchannels 0, 1 and 2 from subchannels {0,1,2,3,4} are used. As shown in FIG. 5A, subchannels 0-2 are selected in RB set 0, and subchannels 0-2 are selected in RB set 1.

In some example embodiments, the indication field may include a first indication field for indicating the number of allocated RB sets, e.g., using 2bits to indicate number of used RB sets in case of maximum 4 RB sets on the carrier. Bits 00 represents 1 RB set is used. Bits 01 represent 2 RB sets are used. Bits 10 represents 3RB sets are used. Bits 11 represents 4 RB sets are used. The first allocated RB set among the allocated RB sets is the RB set where the SCI is transmitted or the lowest RB set of the allocated RB sets for PSCCH/PSSCH transmission.

In some example embodiments, the indication field may include a second indication field to indicate the index of the starting RB set and the number of contiguously allocated RB sets in SLIV manner (start and length indication value).

In some example embodiments, the configuration information may indicate that selecting different subchannels in each RB set. The SCI field may include an indication field indicating a set of subchannel indexes and a set of RB set indexes. In some example embodiments, if the configuration information indicates a terminal device can select different subchannels in each RB set, the terminal device can select same or different the subchannels or subchannel indexes in each RB set.

In this case, the subchannel index in each RB set can be same. For example, as shown in FIG. 5A, indication field may include 20 bits (11000 11000 00000 00000) in bitmap manner, the first portion of bits ‘11100’ represents that subchannels {0,1,2} in RB set 1 are used, the second portion of bits ‘11100’ represents that subchannels {0,1,2} in RB sets 2 are used, and the third portion of bits ‘00000’ and the fourth portion of bits ‘00000’ represent that none of subchannels in RB sets 3 and 4 are used. As shown in FIG. 5A, subchannels 0-2 are selected in RB set 0, and subchannels 0-2 are selected in RB set 1.

In this case, the subchannel index in each RB set can be same. For example, as shown in FIG. 5B, indication field may include 20 bits (10100 01010 10010 00000) in bitmap manner. As shown in FIG. 5B, subchannels 0 and 2 are selected in RB set 0, and subchannels 1 and 3 are selected in RB set 1, and subchannels 0 and 3 are selected in RB set 2.

FIG. 2B illustrates another example signaling process 200B for configuration for sidelink transmissions according to some embodiments of the present disclosure. For the purpose of discussion, the signaling process 200B will be described with reference to FIG. 1. It would be appreciated that although the signaling process 200B has been described in the communication environment 100 of FIG. 1, this signaling process 200B may be likewise applied to other communication scenarios.

As shown in FIG. 2B, the network device 102 determines (212) configuration information. In some example embodiments, the configuration information can indicate a minimum number and a maximum number of RB sets for a sidelink transmission. Alternatively or additionally, the configuration information can indicate selecting at least one same or different subchannel in each RB set for the sidelink transmission. In some further embodiments, the configuration information may indicate both of the two items.

The network device 104 transmits (216), via a transceiver, the configuration information 218 to the terminal device 102. The terminal device 102 receives (214) the configuration information 218 from the network device 104.

In some example embodiments, the network device 104 may determine configuration information indicating that the terminal device is allowed to select non-continuous RB sets in a resource selection procedure. The network device 104 may transmit the further determined configuration information.

In some example embodiments, the network device 104 may determine configuration information indicative of a CBR threshold or a CR threshold for the terminal device 102 to determine whether to select at least one same or different subchannel in each RB set. The network device 104 may transmit the further determined configuration information.

In some example embodiments, the network device 104 may transmit the configuration information via higher layer signalling per resource pool, for example, via a RRC signaling. For brevity, other corresponding actions performed by the network device 104 will not be discussed herein.

As such, by implementing FIGS. 2A and 2B, subchannel is not limited in one RB set. The selected resource for sidelink transmission can include multiple subchannels or interlaces, and also span on multiple RB set.

### Example Method

FIG. 6 illustrates a flowchart of an example method 600 for configuration for sidelink transmissions according to some other embodiments of the present disclosure. As shown in FIG. 6, at block 602, the terminal device 102 obtains configuration information indicative of at least one of (i) a minimum number and a maximum number of RB sets for a sidelink transmission, or (ii) selecting at least one same or different subchannel in each RB set for the sidelink transmission.

At block 604, the terminal device 102 selects at least one resource for the sidelink transmission by performing a resource selection procedure based on the configuration information. At block 606, the terminal device 102 transmits, via a transceiver, SCI indicative of the at least one resource.

In some example embodiments, the terminal device 102 may perform the resource selection procedure by determining, by a higher layer of the terminal device 102, a number of RB sets for the sidelink transmission within a range from the minimum number to the maximum number of RB sets. The terminal device 102 may further perform the resource selection procedure by providing, by the higher layer to a physical layer of the terminal device 102, a parameter indicative of the determined number of RB sets.

In some example embodiments, the terminal device 102 may perform the resource selection procedure by determining, by a higher layer of the terminal device 102, at least one available RB set for the sidelink transmission within a range from the minimum number to the maximum number of RB sets. The terminal device 102 may further perform the resource selection procedure by providing, by the higher layer to a physical layer of the terminal device 102, a parameter indicative of the determined at least one available RB set.

In some example embodiments, the at least one available RB set may be determined based on a consistent LBT failure detection result related to RB sets within the range from the minimum number to the maximum number of RB sets.

In some example embodiments, the terminal device 102 may perform the resource selection procedure by selecting at least one candidate resource from continuous RB sets in frequency domain. In some example embodiments, the terminal device 102 may obtain further configuration information indicating that the terminal device 102 is allowed to select non-continuous RB sets in the resource selection procedure.

In some example embodiments, performing the resource selection procedure may further comprise selecting at least one candidate resource from non-continuous RB sets in frequency domain. In some example embodiments, performing the resource selection procedure may further comprise selecting at least one candidate resource from continuous RB sets in frequency domain.

In some example embodiments, performing the resource selection procedure may comprise determining, by a higher layer of the terminal device 102 and based on the configuration information, to select at least one same subchannel in each RB set for the sidelink transmission. In some example embodiments, performing the resource selection procedure may further comprise providing, by the higher layer to a physical layer of the terminal device 102, a parameter indicating to select at least one same subchannel in each RB set for the sidelink transmission. In some example embodiments, performing the resource selection procedure may further comprise reporting, by the physical layer to the higher layer, at least one candidate resource with at least one same subchannel index in each RB set.

In some example embodiments, performing the resource selection procedure may comprise determining, by a higher layer of the terminal device 102 and based on the configuration information, to select at least one different subchannel in each RB set for the sidelink transmission. In some example embodiments, performing the resource selection procedure may further comprise providing, by the higher layer to a physical layer of the terminal device, a parameter indicating that the terminal device 102 is allowed to select at least one different subchannel in each RB set for the sidelink transmission. In some example embodiments, performing the resource selection procedure may further comprise reporting, by the physical layer to the higher layer, at least one candidate resource with at least one same or different subchannel index in each RB set.

In some example embodiments, the configuration information may be further indicative of a channel busy ratio (CBR) threshold or a channel occupancy ratio (CR) threshold for the terminal device 102 to determine whether to select at least one same or different subchannel in each RB set.

In some example embodiments, performing the resource selection procedure may comprise determining, by a higher layer of the terminal device 102, to select at least one different subchannel in each RB set for the sidelink transmission, in the case that a measured CBR or a measured CR of an associated resource pool is equal to or greater than the CBR threshold or the CR threshold. In some example embodiments, performing the resource selection procedure may further comprise determining, by the higher layer, to select at least one same subchannel in each RB set for the sidelink transmission, in the case that the measured CBR or the measured CR is less than the CBR threshold or the CR threshold.

In some example embodiments, performing the resource selection procedure may comprise determining, by a higher layer of the terminal device 102, to select at least one different subchannel in each RB set for the sidelink transmission, in the case that a measured CBR or a measured CR of an associated resource pool is greater than the CBR threshold or the CR threshold. In some example embodiments, performing the resource selection procedure may further comprise determining, by the higher layer, to select at least one same subchannel in each RB set for the sidelink transmission, in the case that the measured CBR or the measured CR is equal to or less than the CBR threshold or the CR threshold.

In some example embodiments, performing the resource selection procedure may comprise providing, by a higher layer to a physical layer of the terminal device 102, a number of RB sets or at least one RB set index to be used for the sidelink transmission in a slot. In some example embodiments, performing the resource selection procedure may further comprise providing, by a higher layer to a physical layer of the terminal device 102, a number of sub-channels to be used for the sidelink transmission per RB set in the slot.

In some example embodiments, performing the resource selection procedure may comprise providing, by a higher layer to a physical layer of the terminal device 102, a number of RB sets or at least one RB set index to be used for the sidelink transmission in a slot. In some example embodiments, performing the resource selection procedure may further comprise providing, by a higher layer to a physical layer of the terminal device 102, one or more numbers of subchannels to be used for the sidelink transmission corresponding to one or more RB sets in the slot.

In some example embodiments, the SCI may be further indicative of at least one RB set used for the sidelink transmission and at least one subchannel in each RB set used for the sidelink transmission. In some example embodiments, the SCI may comprise a bitmap, a first part of the bitmap may be indicative of the at least one RB set and a second part of the bitmap may be indicative of the at least one subchannel in each RB set.

In some example embodiments, the SCI may be further indicative of a set of RB sets and subchannels in the set of RB sets used for the sidelink transmission. In some example embodiments, the SCI may comprise a bitmap including multiple parts corresponding to the set of RB sets, and a part among the multiple parts may be indicative of a set of subchannels in a RB set corresponding to the part.

In some example embodiments, the configuration information may be preconfigured configuration information per resource pool. In some example embodiments, the configuration information may be configuration information per resource pool configured via higher layer signaling.

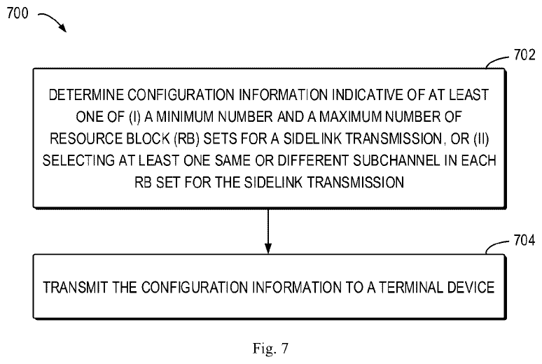

FIG. 7 illustrates another flowchart of an example method 700 for configuration for sidelink transmissions according to some other embodiments of the present disclosure. As shown in FIG. 7, at block 702, the network device 104 determines configuration information indicative of at least one of (i) a minimum number and a maximum number of resource block (RB) sets for a sidelink transmission, or (ii) selecting at least one same or different subchannel in each RB set for the sidelink transmission. At block 704, the network device 104 transmits, via a transceiver, the configuration information to a terminal device.

In some example embodiments, the network device 104 may transmit, via the transceiver to the terminal device 102, further configuration information indicating that the terminal device 102 is allowed to select non-continuous RB sets in a resource selection procedure.

In some example embodiments, the configuration information may be further indicative of a channel busy ratio (CBR) threshold or a channel occupancy ratio (CR) threshold for the terminal device 102 to determine whether to select at least one same or different subchannel in each RB set. In some example embodiments, the configuration information may be transmitted via higher layer signalling per resource pool.

In this way, by implementing methods 600 and 700, subchannel is not limited in one RB set. The selected resource for SL transmission can include multiple subchannels or interlaces, and also span on multiple RB set.

In view of the above, subchannel is not limited in one RB set. The selected resource for SL transmission can include multiple subchannels or interlaces, and also span on multiple RB set. New higher layer indication is provided. The new higher layer indication on the number of subchannel is allowed to span on frequency resource size, and candidate resource reporting for SL-U can be extended to multiple RB set.

### Example Apparatus

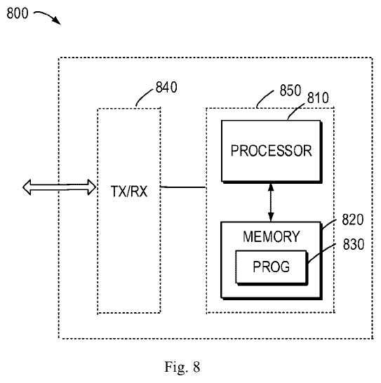

FIG. 8 illustrates a simplified block diagram of a device 800 that is suitable for implementing embodiments of the present disclosure. The device 800 can be considered as a further example implementation of the terminal device 102 or the network device 104 as shown in FIG. 1. Accordingly, the device 800 can be implemented at or as at least a part of the terminal device 102 or the network device 104.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this disclosure may have several ones. The communication interface may represent any interface that is necessary for communication with other network elements, such as X2 interface for bidirectional communications between eNBs or gNBs, S1 interface for communication between a Mobility Management Entity (MME)/Serving Gateway (S-GW) and the eNB or gNB, Un interface for communication between the eNB or gNB and a relay node (RN), or Uu interface for communication between the eNB or gNB and a terminal device.

The program 830 is assumed to include program instructions that, when executed by the associated processor 810, enable the device 800 to operate in accordance with the embodiments of the present disclosure, as discussed herein with reference to FIGS. 1-7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device comprising:
at least one memory; and
at least one processor coupled with the at least one memory and operable to cause the terminal device to:
obtain configuration information indicative of at least one of a minimum number of resource block (RB) sets or a maximum number of RB sets for a sidelink transmission, or a selection of at least one same subchannel or at least one different subchannel in each RB set for the sidelink transmission;
select at least one resource for the sidelink transmission by performing a resource selection procedure based on the configuration information; and
transmit sidelink control information (SCI) indicative of the at least one resource.

2. The terminal device of claim 1, wherein performing the resource selection procedure comprises:
determining, by a higher layer of the terminal device, a number of RB sets for the sidelink transmission within a range from a minimum number of RB sets to a maximum number of RB sets; and
providing, by the higher layer to a physical layer of the terminal device, a parameter indicative of the determined number of RB sets.

3. The terminal device of claim 1, wherein performing the resource selection procedure comprises:
determining, by a higher layer of the terminal device, at least one available RB set for the sidelink transmission within a range from a minimum number of RB sets to a maximum number of RB sets; and
providing, by the higher layer to a physical layer of the terminal device, a parameter indicative of the determined at least one available RB set.

4. The terminal device of claim 3, wherein the at least one available RB set is determined based on a consistent listen before talk (LBT) failure detection result related to RB sets within the range from the minimum number of RB sets to the maximum number of RB sets.

5. The terminal device of claim 2, wherein performing the resource selection procedure further comprises:
selecting at least one candidate resource from continuous RB sets in frequency domain.

6. The terminal device of claim 3, wherein the at least one processor is further operable to cause the terminal device to:
obtain further configuration information indicating that the terminal device is allowed to select non-continuous RB sets in the resource selection procedure.

7. The terminal device of claim 6, wherein performing the resource selection procedure further comprises at least one of:
selecting at least one candidate resource from non-continuous RB sets in frequency domain; or
selecting at least one candidate resource from continuous RB sets in frequency domain.

8. The terminal device of claim 1, wherein performing the resource selection procedure comprises:
determining, by a higher layer of the terminal device and based on the configuration information, to select at least one same subchannel in each RB set for the sidelink transmission;
providing, by the higher layer to a physical layer of the terminal device, a parameter indicating to select at least one same subchannel in each RB set for the sidelink transmission; and
reporting, by the physical layer to the higher layer, at least one candidate resource with at least one same subchannel index in each RB set.

9. The terminal device of claim 1, wherein performing the resource selection procedure comprises:
determining, by a higher layer of the terminal device and based on the configuration information, to select at least one different subchannel in each RB set for the sidelink transmission;
providing, by the higher layer to a physical layer of the terminal device, a parameter indicating that the terminal device is allowed to select at least one different subchannel in each RB set for the sidelink transmission, and
reporting, by the physical layer to the higher layer, at least one candidate resource with at least one same or different subchannel index in each RB set.

10. The terminal device of claim 1, wherein the configuration information is further indicative of a channel busy ratio (CBR) threshold or a channel occupancy ratio (CR) threshold for the terminal device to determine whether to select at least one same subchannel or at least one different subchannel in each RB set.

11. The terminal device of claim 10, wherein performing the resource selection procedure comprises:
determining, by a higher layer of the terminal device and in a case that a measured CBR or a measured CR of an associated resource pool is equal to or greater than the CBR threshold or the CR threshold, to select at least one different subchannel in each RB set for the sidelink transmission; and
determining, by the higher layer and in a case that the measured CBR or the measured CR is less than the CBR threshold or the CR threshold, to select at least one same subchannel in each RB set for the sidelink transmission.

12. The terminal device of claim 10, wherein performing the resource selection procedure comprises:
determining, by a higher layer of the terminal device and in a case that a measured CBR or a measured CR of an associated resource pool is greater than the CBR threshold or the CR threshold, to select at least one different subchannel in each RB set for the sidelink transmission; and
determining, by the higher layer and in a case that the measured CBR or the measured CR is equal to or less than the CBR threshold or the CR threshold, to select at least one same subchannel in each RB set for the sidelink transmission.

13. The terminal device of claim 1, wherein performing the resource selection procedure comprises:
providing, by a higher layer to a physical layer of the terminal device, a number of RB sets or at least one RB set index to be used for the sidelink transmission in a slot, and a number of sub-channels to be used for the sidelink transmission per RB set in the slot.

14. The terminal device of claim 1, wherein performing the resource selection procedure comprises:
providing, by a higher layer to a physical layer of the terminal device, number of RB sets or at least one RB set index to be used for the sidelink transmission in a slot, and one or more numbers of subchannels to be used for the sidelink transmission corresponding to one or more RB sets in the slot.

15. (canceled)

16. (canceled)

17. (canceled)

18. (canceled)

19. (canceled)

20. A network device comprising:
at least one memory; and
at least one processor coupled with the at least one memory and operable to cause the network device to:
determine configuration information indicative of at least one of a minimum number of resource block (RB) sets or a maximum number of RB sets for a sidelink transmission, or a selection of at least one same subchannel or at least one different subchannel in each RB set for the sidelink transmission; and
transmit the configuration information to a terminal device.

21. The network device of claim 20, wherein the at least one processor is further operable to cause the network device to:
transmit further configuration information indicating that the terminal device is allowed to select non-continuous RB sets in a resource selection procedure.

22. The network device of claim 20, wherein the configuration information is further indicative of a channel busy ratio (CBR) threshold or a channel occupancy ratio (CR) threshold for the terminal device to determine whether to select at least one same or different subchannel in each RB set.

23. The network device of claim 20, wherein the configuration information is transmitted via higher layer signaling per resource pool.

24. A method performed by a terminal device, the method comprising:
obtaining configuration information indicative of at least one of a minimum number of resource 24 block (RB) sets or a maximum number of RB sets for a sidelink transmission, or a selection of at least one same subchannel or at least one or different subchannel in each RB set for the sidelink transmission;
selecting at least one resource for the sidelink transmission by performing a resource selection procedure based on the configuration information; and
transmitting sidelink control information (SCI) indicative of the at least one resource.

25. A method performed by a network device, the method comprising:
determining configuration information indicative of at least one of a minimum number of resource block (RB) sets or a maximum number of RB sets for a sidelink transmission, or a selection of at least one same subchannel or at least one different subchannel in each RB set for the sidelink transmission; and
transmitting the configuration information to a terminal device.

26. (canceled)
